(19) United States
(12) Patent Application Publication
(10) Pub. No.: US 2017/0314597 A1
(43) Pub. Date: Nov. 2, 2017

(54) IMPROVEMENTS IN OR RELATING TO CONNECTING DEVICES

(71) Applicant: GRIPPLE LIMITED, Sheffield (GB)

(72) Inventor: Alan Somerfield, Lincolnshire (GB)

(73) Assignee: Gripple Limited, South Yorkshire (GB)

(21) Appl. No.: 15/520,361

(22) PCT Filed: Oct. 20, 2015
(86) PCT No.: PCT/GB2015/000290

§ 371 Date: Apr. 19, 2017

(30) Foreign Application Priority Data
Oct. 22, 2014 (GB) 1418811.4
Nov. 3, 2014 (GB) 1419593.7
Oct. 16, 2015 (GB) 1518343.7

(51) Int. Cl. F16B 7/20; F16L 3/24; F16B 5/06; F16L 3/00; F16B 7/00

(52) U.S. Cl. CPC F16B 7/20; F16L 3/24; F16B 5/06; F16B 7/00; F16L 3/00

(57) ABSTRACT

A connecting device (10) for connecting an article to a carrier (14) is disclosed. The connecting device comprises a securing arrangement (12) for securing the connecting device to the article, and an attaching arrangement (26) for attaching the connecting device to the carrier. The attaching arrangement comprises a first projecting formation (28) for engaging the carrier, and a second projecting formation (32) for insertion through the carrier. When the second projecting formation is inserted through the carrier, a portion of the carrier can be received between the first and second projecting formations, thereby attaching the connecting device to the carrier.

This invention relates to connecting devices. This invention also relates to connecting arrangements comprising connecting devices and carriers. More particularly, but not exclusively, this invention relates to connecting devices for suspending articles from supports. This invention also relates to carriers in the form of intermediate mounting clips for mounting connecting devices on supports.

It is often necessary to suspend articles from ceilings or roofs. This is carried out by securing struts in the roof, and thereafter attaching threaded rods to the struts with nuts screwed thereon. The articles are then attached to the threaded rods.

According to one aspect of this invention, there is provided a connecting device for connecting an article to a carrier, the connecting device comprising a securing arrangement for securing the device to the article, and an attaching arrangement for attaching the device to the carrier, wherein the attaching arrangement comprises a first projecting formation for engaging a first face of a portion of the carrier and a second projecting formation for engaging a second face of said portion of the carrier.

According to one aspect of this invention, there is provided a connecting device for connecting an article to a carrier, the connecting device comprising a securing arrangement for securing the connecting device to the article, and an attaching arrangement for attaching the connecting device to the carrier, wherein the attaching arrangement comprises a first projecting formation for engaging the carrier and a second projecting formation for insertion through the carrier, wherein when the second projecting formation is inserted through the carrier, a portion of the carrier can be received between the first and second projecting formations, thereby attaching the connecting device to the carrier.

The first projecting formation may engage a first face of said portion of the carrier. The second projecting formation may engage an opposite second face of said portion of the carrier.

In one embodiment of the connecting device for use with a carrier defining an aperture, the second projecting formation may be inserted through the aperture in use.

According to another aspect of this invention, there is provided a connecting arrangement comprising a connecting device and a carrier, the connecting device comprising a securing arrangement for securing the connecting device to an article, and an attaching arrangement for attaching the connecting device to the carrier, wherein the attaching arrangement comprises a first projecting formation for engaging a first face of a portion of the carrier and a second projecting formation for engaging a second face of said portion of the carrier.

The carrier may comprise a main part, which may define an aperture. The second projecting formation may be inserted through the aperture, wherein when the second projecting formation is inserted through the aperture, said portion of the carrier can be received between the first and second projecting formations, thereby attaching the connecting device to the carrier.

The connecting arrangement may comprise a plurality of the connecting devices, which can be attached to the carrier.

In one embodiment, the carrier may comprise a support. The support may be an elongate support, such as a strut. In another embodiment, the carrier may comprise an intermediate mounting clip for mounting the connecting device to a support.

According to another aspect of this invention, there is provided an intermediate mounting clip for mounting a connecting device as described above to a support, the intermediate mounting clip comprising two opposed resiliently movable portions, the resiliently movable portions being resiliently movable to effect engagement with the support thereby fastening the intermediate mounting clip to the support, wherein each resiliently movable portion has an attaching formation thereon, said attaching formation being cooperable with the attaching arrangement on the connecting device to attach the connecting device to the intermediate mounting clip.

The aforesaid portion of the carrier or intermediate mounting clip may be received between the first and second projecting formations on rotating the attaching arrangement to an attaching position when the second projecting formation is inserted through the carrier or between the resiliently movable portions. The second projecting formation may extend across the first projecting formation.

The attaching arrangement may further include a spacer portion extending between the first and second projecting formations. A gap may be defined between the first and second projecting formations.

The attaching arrangement may be rotated to the attaching position about an axis of rotation extending through the first and second projecting formations. When the attaching arrangement is rotated about the axis of rotation, a portion of the carrier or intermediate mounting clip may be received between the first and second projecting formations. The rotation of the attaching arrangement may be effected by rotation of the connecting device about the aforesaid axis of rotation.

The attaching arrangement may have a bridging element which extends between the first projecting formation and the securing arrangement. The bridging element may be elongate.

The bridging element may have a central axis. In one embodiment, the axis of rotation may be offset relative to the central axis of the bridging element. The axis of rotation may be substantially parallel to the central axis of the bridging element.

The first projecting formation may extend outwardly from the bridging element. The second projecting formation may extend outwardly from the spacer portion. The second projecting formation may extend from the spacer portion in opposite directions relative thereto.

The second projecting formation may have a leading surface and a securing region. The leading surface may be the first region of the second projecting formation to pass over the aforesaid portion of the carrier or intermediate mounting clip when the attaching arrangement is rotated to the attaching position. The attaching surface may engage the carrier or intermediate mounting clip when the attaching arrangement is in the attaching position.

The gap may be larger at the leading surface than at the attaching surface. The leading surface may have a surface that tapers to the attaching surface.

The first projecting formation may extend radially from the bridging element, and may be substantially circular. The second projecting formation may be substantially rectangular having a width greater than its length.

The aperture in the carrier or intermediate mounting clip may be elongate and may have a length greater than the length of the second projecting formation. The width of the aperture in the carrier, or the distance between the attaching formations on the resiliently movable portions, may be greater than the width of the second projecting formation. The length of the second projecting formation may be greater than the width of the aperture, or the distance between the attaching formations on the resiliently movable portions.

The spacer portion may have a stop formation to prevent rotation of the attaching arrangement in one direction. The stop formation may comprise a region of the spacer portion configured to engage the carrier or intermediate mounting clip when the attaching arrangement is rotated in the aforesaid direction. The stop formation may comprise diagonally opposite regions of the spacer portion, the distance between said regions being greater than the width of the aperture.

The spacer portion may have a curved edge to allow rotating of the attaching arrangement relative to the carrier or intermediate mounting clip. The spacer portion may have diametrically opposed curved edges, wherein the diametrical distance between said curved edges is less than the width of the aperture in the carrier or intermediate mounting clip.

The securing arrangement may comprise any suitable securing arrangement for securing the article to the connecting device. An example of such a securing arrangement is disclosed in published GB patent specification number GB2473320.

The intermediate mounting clip may comprise a main part, which may include the resiliently movable portions. The main part may be resiliently deformable to move the resiliently movable portions into engagement with the support.

The main part may have a central portion extending between the two resiliently movable portions. Both resiliently movable portions may extend in the same direction from the central portion. The main part may have a substantially ‘U’ shaped end profile. Each resiliently movable portion may comprise a leaf extending from the central portion. Each of the resiliently movable portions may comprise a respective leaf extending from the central portion.

The attaching formation on each resiliently movable portion may comprise an inwardly extending member to engage the attaching arrangement on the connecting device. The inwardly extending member may have a first surface to engage the first projecting formation. The first surface may be a substantially planar first surface.

The inwardly extending member may have a second surface to engage the second projecting formation. The second surface may be a substantially planar second surface.

The first and second surfaces may be first and second opposite faces of the inwardly extending member. Each inwardly extending member may extend transverse to the respective resiliently movable portion. Thus, the connecting device may be rotated to the attaching position to receive the inwardly extending members between the first and second projecting formations.

An end stop may be provided on one end of each of the inwardly extending member. The inwardly extending members may be arranged substantially opposite each other, so that rotation of the attaching arrangement moves the first and second projecting formations into engagement with the attaching formation.

The end stop on the first inwardly extending member may be on the opposite end thereof to the end stop on the second inwardly extending member. The second projecting formation may engage the end stops when the attaching arrangement is in the attaching position.

A respective aperture may be defined by each of the first and second resiliently movable portions adjacent each inwardly extending member. Each aperture may be defined in a position to receive the first projecting formation.

The intermediate mounting clip may further include fastening means to fasten the intermediate mounting clip to the support. The fastening means may be provided on the resiliently movable portions. The fastening means may be provided on each resiliently movable portion.

The fastening means may comprise a plurality of fastening elements, which may extend outwardly from the respective resiliently movable portion. Each resiliently movable portion may have distal free edge spaced from the central portion. Each resiliently movable portion may have two opposite side edges extending between the distal edges and the central portion.

The fastening means on each resiliently movable portion may comprise an inner fastening element and an outer fastening element. The outer fastening element may be provided adjacent the distal edge of the resiliently movable portion. The inner fastening element may be provided between the outer fastening element and the central portion.

The fastening means may comprise two sets of the inner and outer fastening elements on each of the resiliently movable portions. Each set may be provided on a respective side edge of the resiliently movable portions.

When the intermediate mounting clip is attached to the support, inwardly extending portions of the support are received between the inner and outer fastening elements.

According to another aspect of this invention, there is provided a connecting assembly comprising a connecting device and an intermediate mounting clip for mounting the connecting device on a support, the connecting device comprising a securing arrangement for securing the connecting device to an article, and an attaching arrangement for attaching the connecting device to the intermediate mounting clip, wherein the attaching arrangement comprises a first projecting formation for engaging a first face of a portion of the intermediate mounting clip and a second projecting formation for engaging a second face of said portion of the intermediate mounting clip.

At least one embodiment of the invention will now be described by way of example only, with reference to the accompanying drawings, in which:

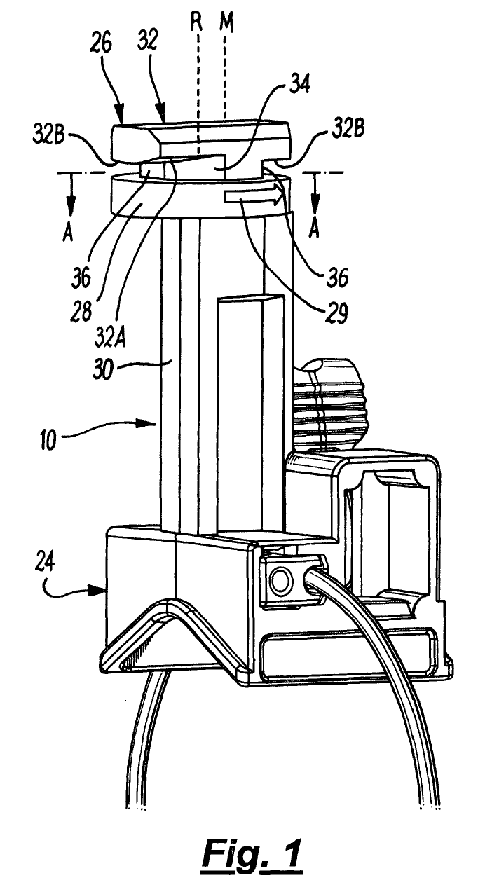

FIG. 1 is a perspective view of a connecting device;

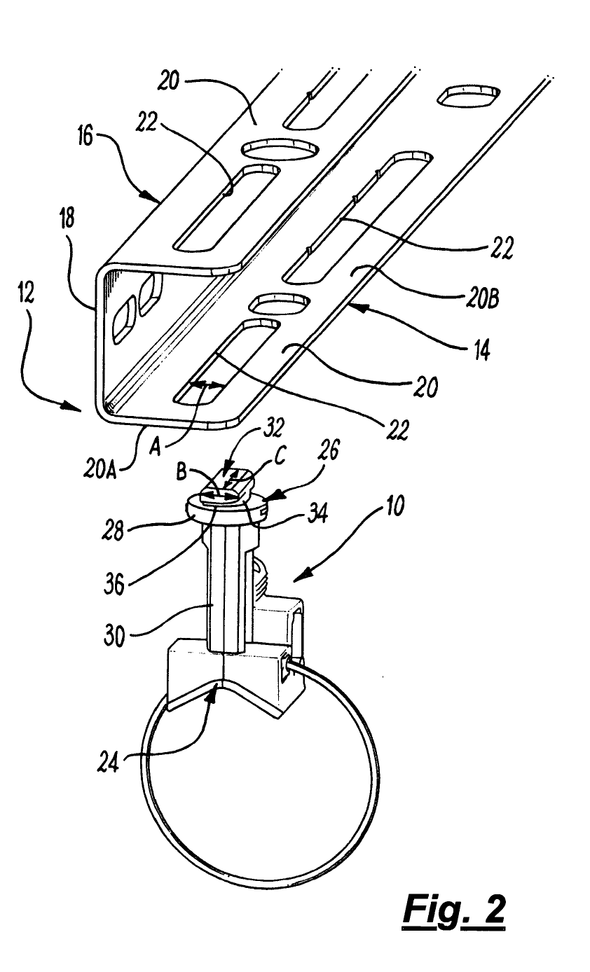

FIG. 2 a connecting arrangement comprising a connecting device and a carrier;

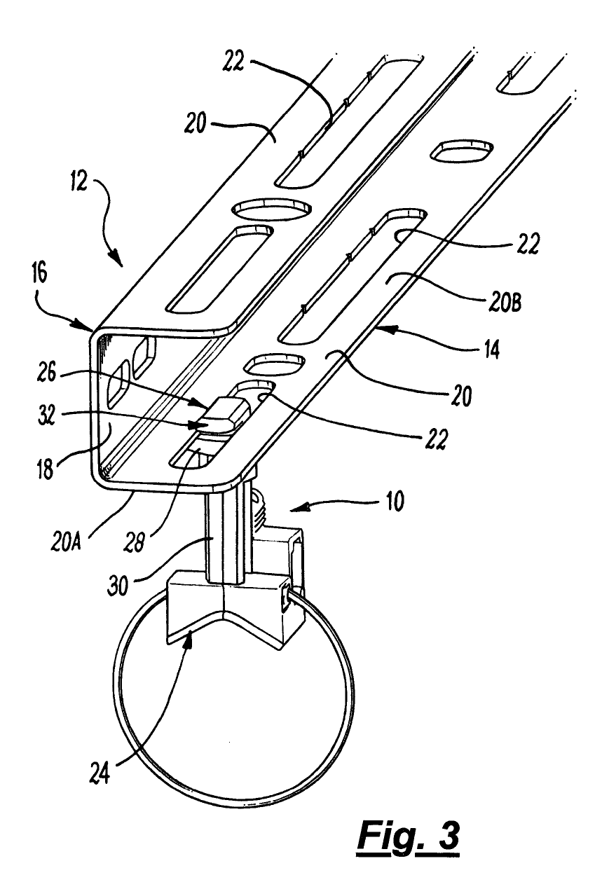

FIG. 3 is a perspective view of connecting arrangement of FIG. 2, showing the connecting device is being attached to the carrier;

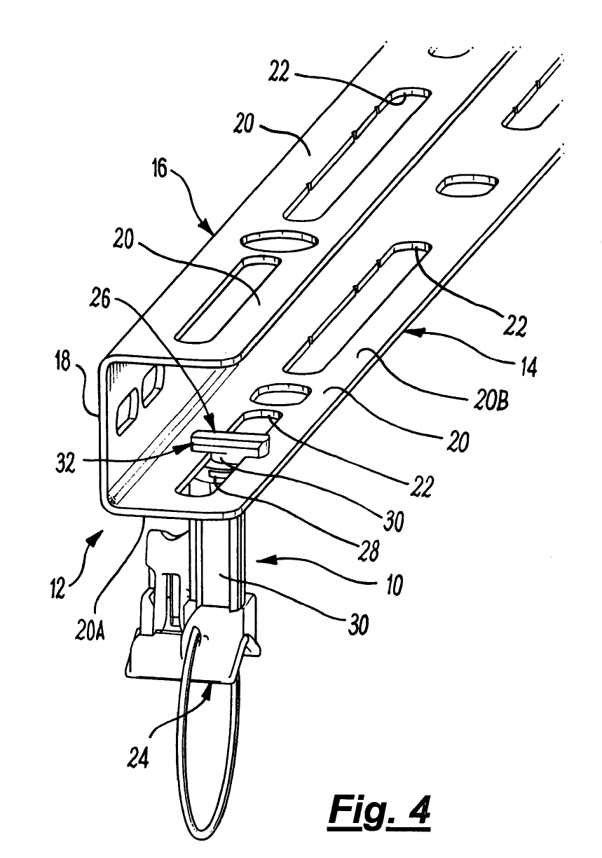

FIG. 4 is a perspective view of connecting arrangement of FIG. 2, showing the connecting device attached to the carrier;

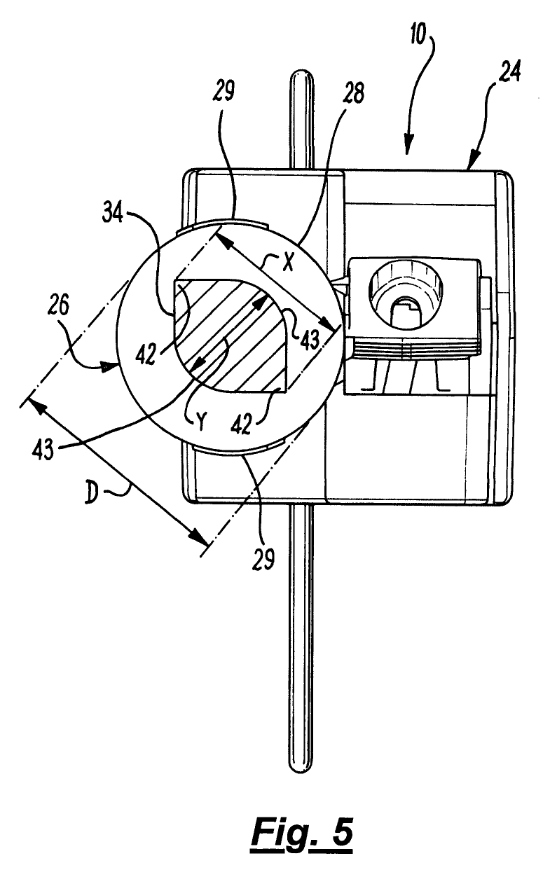

FIG. 5 is a view along the lines A-A in FIG. 1.

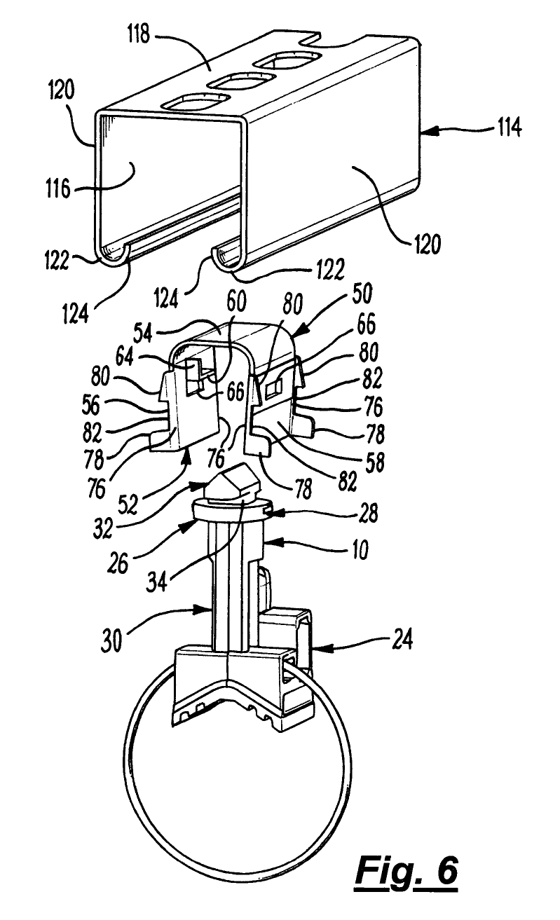

FIG. 6 is a top perspective view of a connecting device, an intermediate mounting clip and a further support;

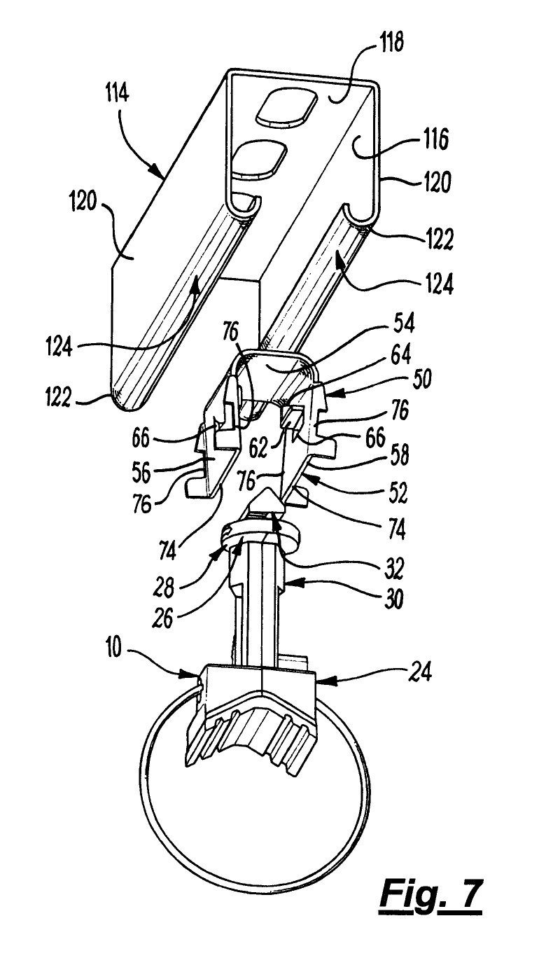

FIG. 7 is a bottom perspective view of the connecting device, the intermediate mounting clip and the further support shown in FIG. 6;

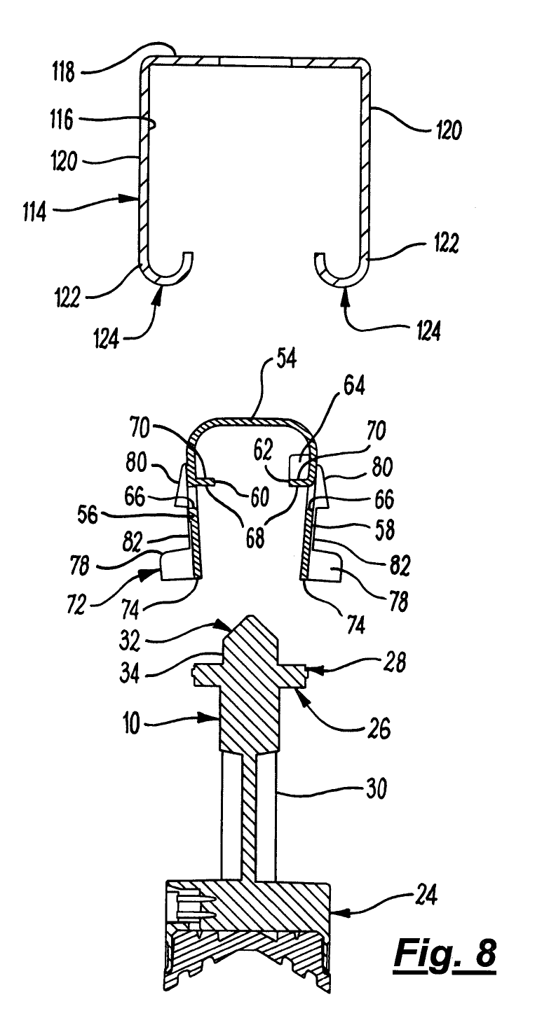

FIG. 8 is a sectional side view of the connecting device, the intermediate mounting clip and the further support shown in FIG. 6;

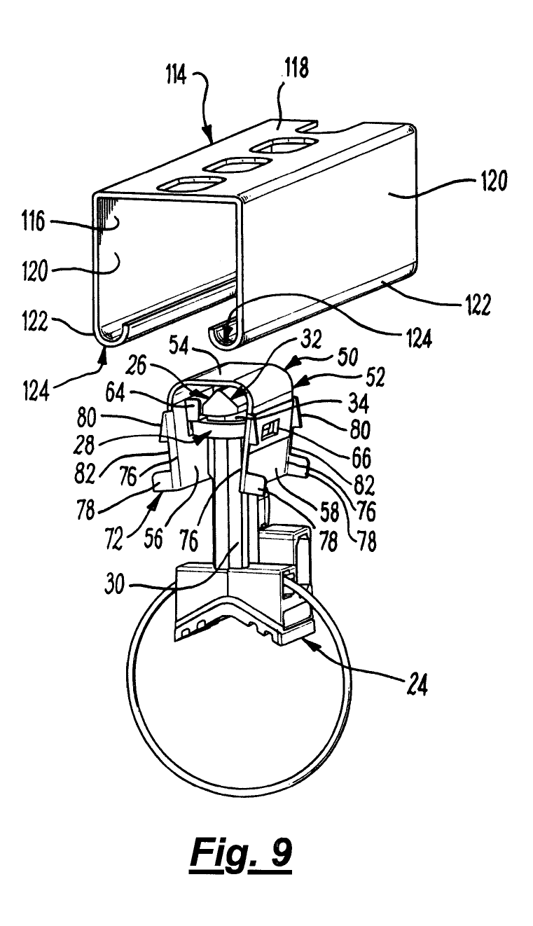

FIG. 9 is a top perspective view of the connecting device attached to the intermediate mounting clip before insertion into the further support;

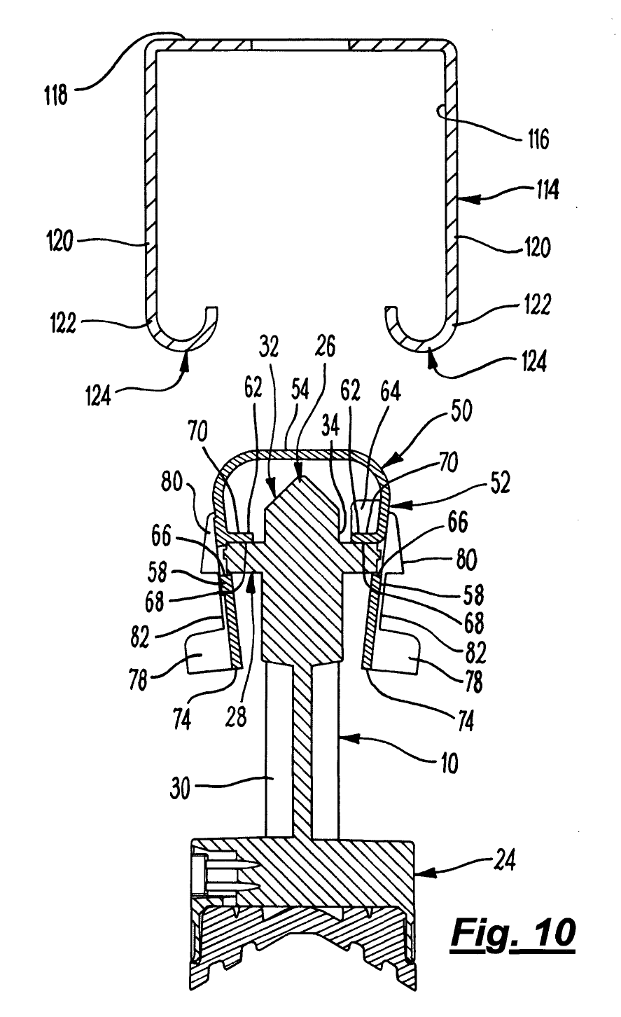

FIG. 10 is a sectional side view of the connecting device attached to the intermediate mounting clip before insertion into the further support;

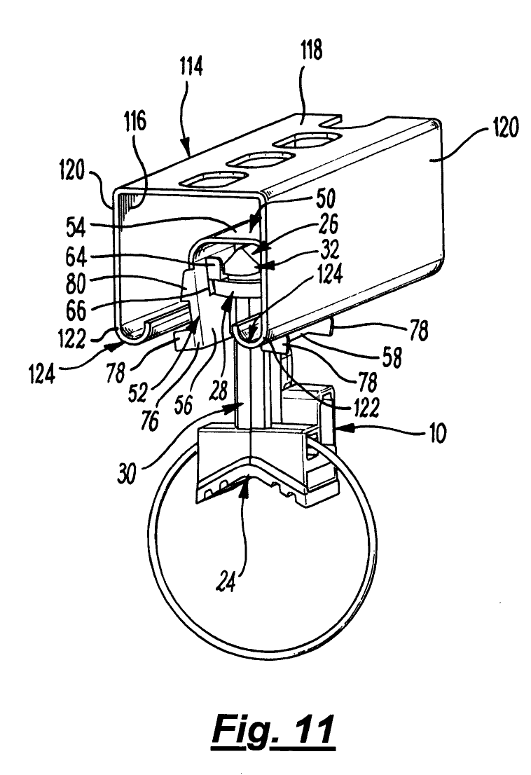

FIG. 11 is a top perspective view of the connecting device attached to the intermediate mounting clip after insertion into the further support;

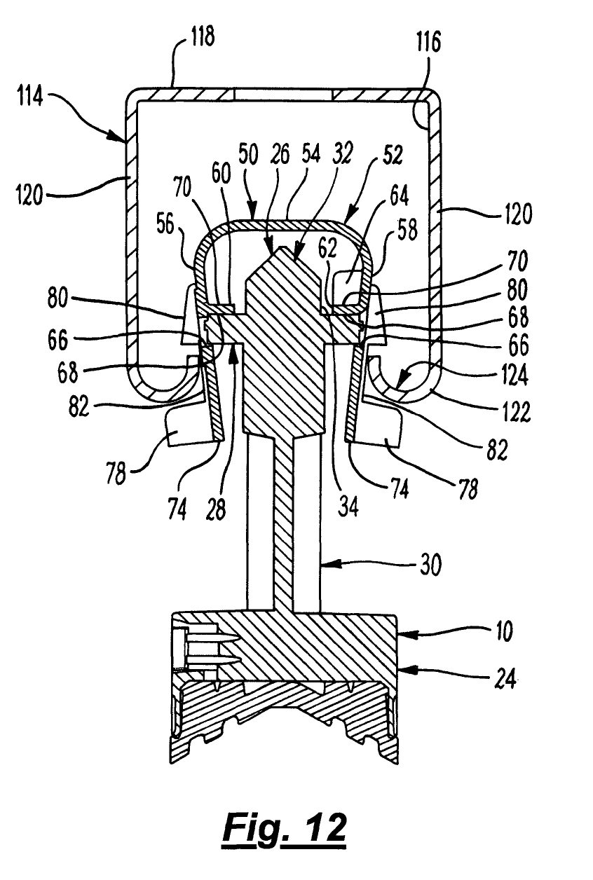

FIG. 12 is a sectional side view of the connecting device attached to the intermediate mounting clip after insertion into the further support;

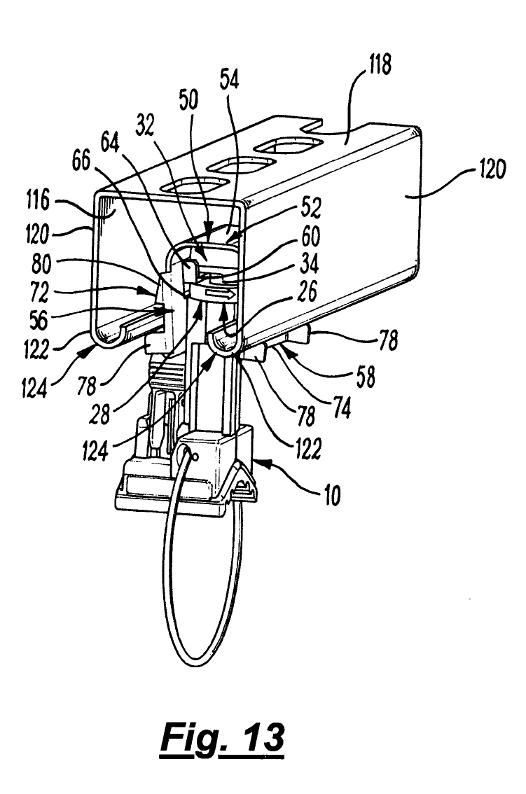

FIG. 13 is a top perspective view of the connecting device attached to the intermediate mounting clip after the connecting device has been rotated to mount the connecting device on the further support;

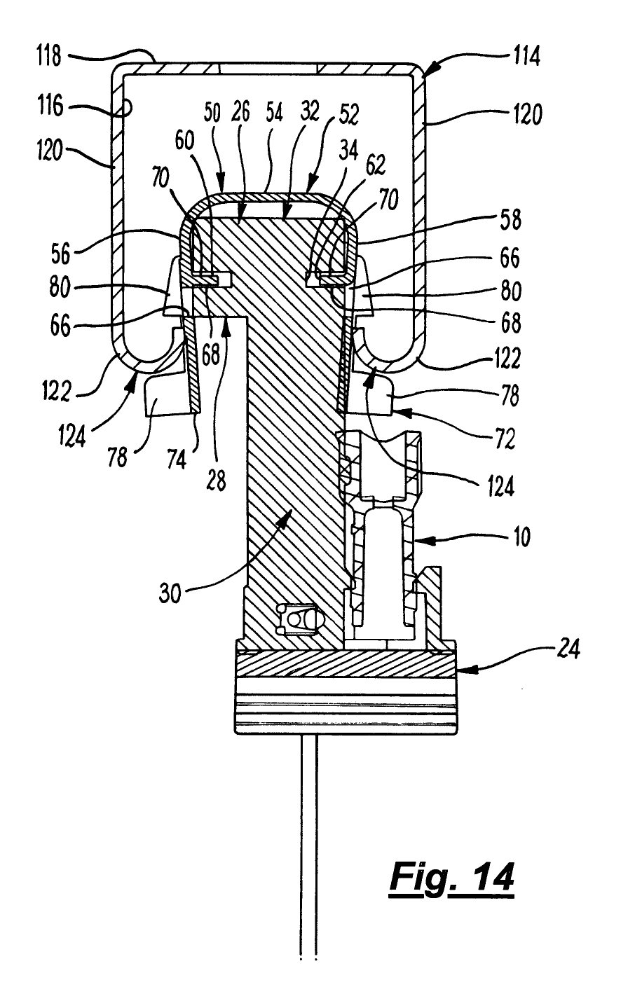

FIG. 14 is a sectional side view of the connecting device attached to the intermediate mounting clip after the connecting device has been rotated to mount the connecting device on the further support; and

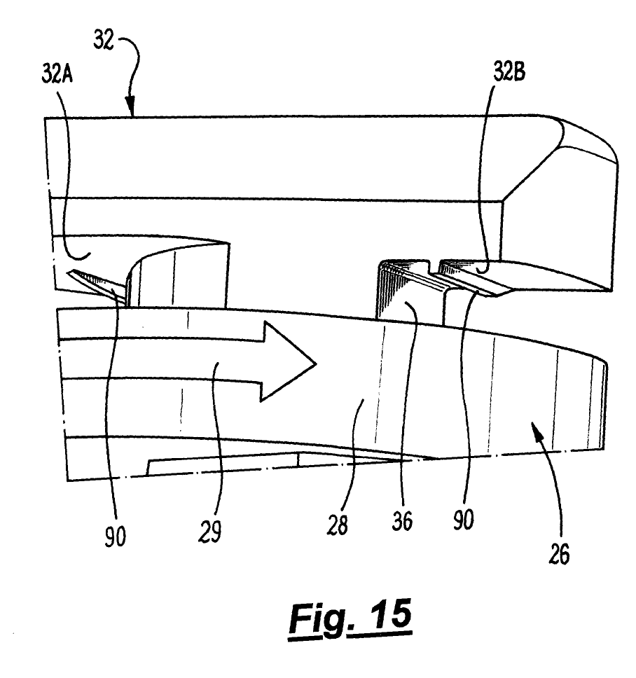

FIG. 15 is a close up view of an attaching arrangement of a further connecting device.

FIG. 1 shows a connecting device 10 for use as part of a connecting arrangement 12 (see FIGS. 2 to 4). The connecting arrangement 12 comprises the connecting device 10 and a carrier in the form of an elongate support 14.

The support 14 is in the form of an elongate strut comprising a main part 16 being formed of an elongate central strip 18 and two elongate substantially parallel transverse strips 20 extending from opposite edges of the central strip 18 so that the support 14 has an end profile that is substantially U shaped.

Apertures in the form of elongate slots 22 are defined in the transverse strips 20 and in the central strip 18. The support 14 can be installed in the roof or ceiling of a building so that articles, for example pipes, can be suspended therefrom.

The connecting device 10 is provided to connect the article to the support 14, and comprises a securing arrangement 24 for securing the article to the connecting device 10 and an attaching arrangement 26 for attaching the connecting device 10 to the support. The securing arrangement 24 can be any suitable securing arrangement. In the embodiment shown, the securing arrangement 24 is similar to the securing arrangement 24 published in patent specification No. GB2473320.

The attaching arrangement 26 comprises a first projecting formation 28 and a bridging element 30 extending from the first projecting formation 28 to the securing arrangement 24. The bridging element 30 has a central main axis M. The attaching formation has an axis of rotation R that is offset from, and parallel to, the central main axis M.

The first projecting formation 28 is substantially circular in configuration having a diameter D (see FIG. 5) which is greater than the width A of the slots 22 in the support 14. An indicator arrow 29 is marked on the first projecting formation 28 to indicate the direction in which the attaching arrangement should be rotated to attach the connecting device 10 to the support 14, as explained below.

The attaching arrangement 26 further includes a second projecting formation 32 and a spacer portion 34 between the first and second projecting formations 28, 32, whereby a gap 36 is defined between the first and second projecting formations 28, 32 on each side of the spacer portion 34. The size of each gap 36 is substantially equal to, or greater than, the thickness of the central strip 18 and the transverse strips 20, thereby allowing regions of the support 14 to be received in the gap 32.

The second projecting formation 32 has a substantially rectangular shape, and projects from the spacer portion 34 on opposite sides thereof across the first projecting formation 28. The second projecting formation 32 has a width B that is less than the width A of the elongate slots 22 in the support 14, and a length C that is greater than the width A of the elongate slots 22 in the support 14.

In use, the attaching arrangement 26 is inserted into one of the elongate slots 22, for example, in one of the transverse strips 20 of the support 14, so that the first and second projecting formations 28, 30 are disposed on opposite first and second faces 20A, 20B of the transverse strip 20. In this position, the spacer portion 32 extends through the slot 22.

The attaching arrangement 26 can only be inserted into the slot until the circular first projecting formation 28 engages a first face 20A of the transverse strip 20. When so engaged, the second projecting formation 32 is disposed in engagement with the opposite second face 20B.

The attaching arrangement 26 is rotated about the axis of rotation R in the direction indicated by the arrow 29 to an attaching position (see FIG. 4), in which the second projecting formation 32 is disposed over the aforesaid regions of the transverse strip 20.

Referring to FIG. 1, the second projecting formation 32 has a leading surface 32A and an attaching surface 32B. The leading surface 32A is the first surface of the second projecting formation 32 to pass over the aforesaid region of the transverse strip 20 when the attaching arrangement 26 is rotated in the direction indicated by the arrow 29 to the attaching position.

The attaching surface 32B engages the transverse strip 20 when the attaching arrangement 26 is in the attaching position. The gap 36 is larger at the leading surface 32A than at the attaching surface 32B. The leading surface 32A tapers to the attaching surface 32B.

The securing arrangement 24 is fixedly mounted on the attaching arrangement 26 by the bridging element 30. Thus, rotating the attaching arrangement 26 rotates the connecting device 10. The connecting device 10 can be rotated by 90° about its axis of rotation R.

In the embodiment shown, the axis of rotation R is offset from the central main axis M of the bridging element 30. If desired, in an alternative embodiment, the axis of rotation can be coaxial with the central axis.

When so rotated, the second projecting formation 32 moves from the position in which the second projecting formation 32 extends parallel to the elongate slot 22, as shown in FIG. 3, to the position where it extends at right angles to the elongate slot 22, as shown in FIG. 4.

In the position shown in FIG. 4, a region of the transverse strip 20 adjacent the edge of the elongate slot 22 is received in the gap 36 between the first and second projecting formations 28, 32. When so disposed, the attaching arrangement 26 and the connecting device 10 are attached to the support 14.

Referring to FIG. 5, the spacer portion 34 is provided with a stop formation 40 in the form of diametrically opposed corner regions 42. The spacer portion 40 has opposite sides 43 that are convexly curved and extend between the opposite corner regions 42.

The spacer portion 34 has a main dimension X between the corner regions 42, wherein the length of the dimension X is greater than the width A of the elongate slot 22.

The spacer portion 34 has a transverse dimension Y between the opposite sides 43, the transverse dimension Y being at a right angle to the dimension X. The length of the transverse dimension Y is less than the width A of the elongate slot 22. As a result, the connecting device 10 can only be rotated in one direction (as indicated by the arrows 29) when the attaching arrangement 26 is inserted through the elongate slot 22.

The connecting arrangement 12 comprises a plurality of the connecting devices 10 attached to the support 14 at spaced slots 22 along the support 14. Thus, the plurality of the connecting devices 10 connect the article (for example a pipe) to the support 14.

There is thus described a connecting device 10 for connecting an article to a support 14, which provides a simple and efficient means for connecting the article to the support 14.

Referring to FIGS. 6 to 14, an intermediate mounting clip 50 is provided where the connecting device 10 is to be mounted on a further support 114 a defining a recess 116 between a central strip 118 and a pair of transverse strips 120 extending from the central strip 118. Each of the transverse strips 120 has a free edge region 122 comprising an inwardly curved edge portion 124. The further support 114 is known in the art as a unistrut. In such a case, it is not possible to attach the connecting device 10 directly to the further support 114. The connecting device 10 is attached to a carrier in the form of the intermediate mounting clip 50, which is used to mount the connecting device 10 within the recess 116 defined by the further support 114.

The connecting device 10 shown in FIGS. 6 to 14 is the same as the connecting device 10 shown in FIGS. 1 to 5 and the features of the connecting device 10 in FIGS. 6 to 14 have been designated with the same reference numerals as the corresponding features in FIGS. 1 to 5.

The intermediate mounting clip 50 comprises a resiliently deformable main part 52 which has a substantially ‘U’ shaped end profile. The main part 52 comprises a central portion 54 and two resiliently movable portions in the form of two leaves 56, 58. The leaves 56, 58 extend from the central portion 54 in the same direction, and are disposed opposite each other.

Each of the leaves 56, 58 has an attaching formation in the form of an inwardly extending member 60, 62 in the form of a substantially flat strip. The inwardly extending members 60, 62 are arranged opposite each other.

The diameter D (see FIG. 5) of the circular first projecting formation 28 is greater than the distance between the inwardly extending members 60, 62. The width B (see FIG. 2) of the second projecting formation 32 is less than the distance between the inwardly extending members 60, 62. Also, the length C of the second projecting formation 32 is greater than the distance between the inwardly extending members 60, 62.

A stop member 64 is provided at the opposite end of each inwardly extending member 60, 62. The stop member 64 on one of the inwardly extending members 60 is disposed at the opposite end thereof to the stop member 64 on the other inwardly extending member 62.

Each of the leaves 56, 58 defines a rectangular aperture 66 adjacent the respective inwardly extending member 60, 62. The apertures 66 are defined in the leaves 56, 58 opposite each other. In the orientation of the intermediate mounting clip 50 shown in FIGS. 6 to 14, the rectangular apertures 66 are defined beneath the respective inwardly extending members 60, 62.

Each of the inwardly extending members 60, 62 has first and second opposite faces 68, 70 having substantially planar surfaces. The first face 68 faces the rectangular aperture 66, and the second face 70 faces the central portion 54.

The leaves 56, 58 are provided with fastening means 72 to fasten the intermediate mounting clip 50 to the further support 114. Each of the leaves 56, 58 has a distal edge 74 spaced from the central portion 54, and a pair of side edges 76 extending from the distal edge 74 to the central portion 54.

In the embodiment shown, the fastening means 72 are provided on each of the side edges 76 of the leaves 56, 58. The fastening means 72 comprises outer and inner fastening elements 78, 80 on each of the side edges 76.

Each outer fastening element 78 is provided on the side edges 76 of the leaves 56, 58 adjacent the distal edges 74. Each inner fastening element 80 is provided on the side edges 76 of the leaves 56, 58 between the distal edges 74 and the central portion 54.

In the embodiment shown, each of the outer fastening elements 78 is substantially flat and rectangular in shape, and each of the inner fastening elements 80 is substantially flat and triangular in shape. A respective web element 82 extends between the inner and outer fastening elements 78, 80.

In order to mount the connecting device 10 on the support 114, the connecting device is attached to the intermediate mounting clip 50 (see FIGS. 9 and 10). In order to do so, the attaching arrangement 26 is oriented so that the second projecting formation 32 can pass between the inwardly extending members 60, 62. The attaching arrangement 26 is then inserted between the leaves 56, 58 until the first projecting formation 28 engages the first face 68 of each inwardly extending member 60, 62.

In this position, the first projecting formation 28 is partially received in each of the opposite apertures 66, thereby holding the connecting device 10 on the intermediate mounting clip 50.

The intermediate mounting clip 50, with the connecting device 10 held thereon, is inserted into the recess defined by the further support 114 so that the leaves 56, 58 engage the transverse strips 120 (see FIGS. 11 and 12). The inwardly curved edge portions 124 are received between the outer and inner fastening elements 78, 80 on each of the side edges 76, thereby holding the intermediate mounting clip 50 on the further support 114.

The connecting device 10 can then be rotated about its axis of rotation R to the position shown in FIGS. 13 and 14, in which the second projecting formation 32 is rotated across the second faces 70 of the inwardly extending members 60, 62 into engagement therewith. The connecting device 10 is rotated until the second projecting formation 32 engages both of the stop members 64.

Rotation of the connecting device 10 causes the second projecting formation 32 to rotate into engagement with the leaves 56, 58, urging the leaves 56, 58 outwardly into tighter engagement with the transverse strips 120 of the further support 114. The outer and inner fastening elements 78, 80 engage the inwardly curved edge portions 124, and prevent the intermediate mounting clip from being dislodged from the further support 114.

As a result, the intermediate mounting clip 50 allows the connecting device to be mounted on the further support, thereby allowing the connecting device 10 to connect an article to the further support 114.

Various modifications can be made without departing from the scope of the invention. For example, as mentioned above, the securing arrangement 24 can be any other suitable securing arrangement.

A further modification is shown in FIG. 15, which is the same as the connecting device 10 shown above, with the exception that crush ribs 90 are provided on the second projecting portion 32 and extend from the leading surface 32A to the attaching surface 32B.

The crush ribs 90 are provided to accommodate differences in the thickness of the elongate central strip 18 of the support 14. Central strips 18 having a larger thickness crush the ribs 90, whereas central strips 18 having a smaller thickness engage the ribs 90.

1-50. (canceled)

51. A connecting assembly comprising: a connecting device for connecting an article to a support, and an intermediate mounting clip for mounting the connecting device on a support, the connecting device comprising a securing arrangement for securing the connecting device to an article, and an attaching arrangement for attaching the connecting device to the intermediate mounting clip, wherein the attaching arrangement comprises a first projecting formation for engaging a first face of a portion of the intermediate mounting clip and a second projecting formation for insertion through said portion of the intermediate mounting clip to engage a second face of said portion of the intermediate mounting clip.

52. A connecting assembly according to claim 51, wherein the first projecting formation engages a first face of said portion of the intermediate mounting clip, and the second projecting formation engages an opposite second face of said portion of the intermediate mounting clip, wherein the attaching arrangement further includes a spacer portion extending between the first and second projecting formations, a gap being defined between the first and second projecting formations, and wherein the attaching arrangement is rotatable to the attaching position about an axis of rotation extending through the first and second projecting formations, whereby when the attaching arrangement is rotated about the axis of rotation, a portion of the intermediate mounting clip can be received between the first and second projecting formations.

53. A connecting assembly according to claim 52, wherein the spacer portion has a stop formation to prevent rotation of the attaching arrangement in one direction when the attaching arrangement is in the attaching position, the stop formation comprising a region of the spacer portion configured to engage the intermediate mounting clip when the attaching arrangement is rotated in the aforesaid direction to the attaching direction.

54. A connecting assembly according to claim 53, wherein the stop formation comprises diagonally opposite regions of the spacer portion, the distance between said regions being greater than the width of the aperture, and wherein the spacer portion has substantially diametrically opposed curved edges, the diametrical distance between said curved edges being less than the width of the aperture in the intermediate mounting clip.

55. A connecting assembly according to claim 51, wherein the attaching arrangement has an elongate bridging element which extends between the first projecting formation and the securing arrangement.

56. A connecting assembly according to claim 55, wherein the bridging element has a central axis, the axis of rotation being offset relative to the central axis of the bridging element, and wherein the axis of rotation is substantially parallel to the central axis of the bridging element.

57. A connecting assembly according to claim 51, wherein the second projecting formation has a leading surface and a securing region, the leading surface being the first region of the second projecting formation to pass over the aforesaid portion of the intermediate mounting clip when the attaching arrangement is rotated to the attaching position, wherein the attaching surface engages the intermediate mounting clip when the attaching arrangement is in the attaching position, and wherein the gap is larger at the leading surface than at the attaching surface, the leading surface tapering to the attaching surface.

58. A connecting assembly according to claim 51, wherein the first projecting formation is substantially circular and extends radially from the bridging element, and wherein the second projecting formation is substantially rectangular having a width greater than its length.

59. A connecting assembly according to claim 51, wherein the intermediate mounting clip comprises two opposed resiliently movable portions, the resiliently movable portions being resiliently movable to effect engagement with the support thereby fastening the intermediate mounting clip to the support, wherein each resiliently movable portion has an attaching formation thereon, said attaching formation being cooperable with the attaching arrangement of the connecting device to attach the connecting device to the intermediate mounting clip.

60. A connecting assembly according to claim 59, wherein the distance between the attaching formations on each resiliently movable portion is greater than the width of the second projecting formation, and wherein the distance between the attaching formations on each resiliently movable portion is less than the length of the second projecting formation.

61. A connecting assembly according to claim 59, comprising a main part, which includes the resiliently movable portions, the main part being resiliently deformable to move the resiliently movable portions into engagement with the support, and wherein the main part has a substantially ‘U’ shaped end profile, and each resiliently movable portion comprises a leaf extending from the central portion

62. A connecting assembly according to claim 59, wherein the attaching formation on each resiliently movable portion comprises an inwardly extending member to engage the attaching arrangement on the connecting device, the inwardly extending member having a first surface to engage the first projecting formation, and the inwardly extending member having a second surface to engage the second projecting formation.

63. A connecting assembly according to claim 62, wherein the first and second surfaces are first and second opposite faces of the respective inwardly extending members, each inwardly extending member extending transverse to the respective resiliently movable portion.

64. A connecting assembly according to claim 62, wherein a respective end stop is provided on one end of each of the inwardly extending members, the end stop on the first inwardly extending member being on the opposite end thereof to the end stop on the second inwardly extending member, whereby the second projecting formation of the connecting device can engage the end stops when the attaching arrangement is in the attaching position.

65. A connecting assembly according to claim 62, wherein the inwardly extending members are arranged substantially opposite each other, whereby rotation of the attaching arrangement moves the first and second projecting formations into engagement with the attaching formation.

66. A connecting assembly according to claim 62, wherein a respective aperture is defined by each of the first and second resiliently movable portions adjacent each inwardly extending member, whereby each aperture is defined in a position to receive the first projecting formation.

67. A connecting assembly according to claim 62, wherein the intermediate mounting clip further includes fastening means to fasten the intermediate mounting clip to the support, the fastening means being provided on the resiliently movable portions.

68. A connecting assembly according to claim 67, wherein the fastening means comprises a plurality of fastening elements, which extend outwardly from the resiliently movable portions.

69. A connecting assembly according to claim 68, wherein each resiliently movable portion has distal free edge spaced from the central portion, and two opposite side edges extending between the distal edges and the central portion, and wherein each fastening means on the resiliently movable portions comprises an inner fastening element and an outer fastening element, the outer fastening element being provided adjacent the distal edge of the resiliently movable portion, and the inner fastening element is provided between the outer fastening element and the central portion.

70. A connecting assembly according to claim 69, wherein the fastening means comprise two sets of the inner and outer fastening elements on each of the resiliently movable portions, each set being provided on a respective side edge of the resiliently movable portions, whereby when the intermediate mounting clip is attached to the support, inwardly extending portions of the support are received between the inner and outer fastening elements.

71. An intermediate mounting clip for mounting a connecting device of a connecting assembly as claimed in claim 51 to a support, the intermediate mounting clip comprising two opposed resiliently movable portions, the resiliently movable portions being resiliently movable to effect engagement with the support thereby fastening the intermediate mounting clip to the support, wherein each resiliently movable portion has an attaching formation thereon, said attaching formation being cooperable with the attaching arrangement of the connecting device to attach the connecting device to the intermediate mounting clip.

72. A connecting device for connecting an article to a carrier, the connecting device comprising a securing arrangement for securing the connecting device to the article, and an attaching arrangement for attaching the connecting device to the carrier, wherein the attaching arrangement comprises a first projecting formation for engaging the carrier, and a second projecting formation for insertion through the carrier, wherein when the second projecting formation is inserted through the carrier, a portion of the carrier can be received between the first and second projecting formations, thereby attaching the connecting device to the carrier.
